(19) United States
(12) Patent Application Publication
(10) Pub. No.: US 2022/0039378 A1
(43) Pub. Date: Feb. 10, 2022

(54) ALKYL POLYGLYCERYLAMINE BASED SURFACTANTS FOR AGRICULTURAL USE

(71) Applicant: NOURYON CHEMICALS INTERNATIONAL B.V., ARNHEM (NL)

(72) Inventors: Hanamanthsa Shankarsa BEVINAKATTI, Somerset (NL); Shawn ZHU, Stormville, NY (US); Mojahedul ISLAM, Whitehouse Station (NL); Karen Lee WHITE, Bridgewater (NL); Christine PUGLISI, Mountainside (NL)

(73) Assignee: NOURYON CHEMICALS INTERNATIONAL B.V., ARNHEM (NL)

(21) Appl. No.: 17/303,863

(22) PCT Filed: Dec. 12, 2019
(86) PCT No.: PCT/EP2019/084996

§ 371 Date: Jun. 9, 2021

Related U.S. Application Data
(60) Provisional application No. 62/778,558, filed on Dec. 12, 2018.

(51) Int. Cl. A01N 25/30; A01N 37/06; A01N 57/20; A01N 37/40; A01N 37/38; A01N 43/653

(52) U.S. Cl. CPC A01N 25/30; A01N 37/06; A01N 43/653; A01N 37/40; A01N 37/38; A01N 57/20

(57) ABSTRACT

This disclosure provides an agricultural composition comprising at least one agrochemical and at least one alkylamine glycidol surfactant of the structure I:

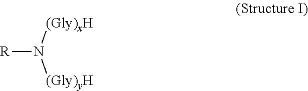

where R is C4-C22 linear or branched, saturated or non-saturated hydrocarbon group with or without pendant hydroxyl groups; x is about 0 to about 30, preferably about 1 to about 20, more preferably about 1 to about 10, more preferably about 1 to about 5; y is about 0 to about 30, preferably about 1 to about 20, more preferably about 1 to about 10, more preferably about 1 to about 5; x+y≥about 2 and up to about 30, and Gly is a glyceryl residue.

### CROSS-REFERENCE TO RELATED APPLICATION

This application is a U.S. National-Stage entry under 35 U.S.C. § 371 based on International Application No. PCT/EP2019/084996, filed Dec. 12, 2019 which was published under PCT Article 21(2) and which claims priority to European Application No. 19170194.5 filed Apr. 18, 2019 and U.S. Provisional Application No. 62/778,558 filed Dec. 12, 2018, which are all hereby incorporated in their entirety by reference.

### FIELD OF THE DISCLOSURE

The present disclosure generally relates to nitrogen containing glycidol surfactants as adjuvants for pesticide formulations.

### BACKGROUND OF THE DISCLOSURE

Many surfactants are used as adjuvants in pesticide formulations. Adjuvants can be used, for example, as a potentiator which is able to enhance the bioefficacy of the pesticides, a wetting agent, an emulsifier, a spreading agent, a deposition aid, a drift control agent, a water conditioner, a crystal inhibitor, a suspension aid, a thickener, or a dispersant. The bioefficacy of pesticides can be enhanced by the addition of appropriate surfactant adjuvants. For example, it is well known that the bioefficacy of herbicides, fungicides, and insecticides can be enhanced by nitrogen containing surfactants such as alkyl amine alkoxylate surfactants. Examples of nitrogen containing surfactants as potentiator adjuvants for herbicides can be found in U.S. Pat. Nos. 4,528,023 and 5,226,943. U.S. Pat. No. 5,226,943 also mentions that the activity of fungicide compositions can be improved by incorporating certain nitrogen containing surfactants. Examples of nitrogen containing surfactants as potentiator adjuvants for insecticides can be found in WO 201280099. Examples of nitrogen containing surfactants as emulsifiers in pesticide emulsions can be found in U.S. Pat. Nos. 5,565,409 and 8,097,563. Examples of nitrogen containing surfactants as thickeners in glyphosate formulations can be found in WO201020599. Examples of nitrogen containing surfactants as drift control agents in pesticide emulsions can be found in WO2013098220.

The production of alkylamine ethoxylates requires a high degree of care and skill. Alkylamine ethoxylates are made by reacting ethylene oxide and alkylamines. Ethylene oxide (EO) is a hazardous gaseous chemical (boiling point 10.7° C.). At room temperature it is a flammable, irritating, and anaesthetic gas. Because of its volatile nature, EO is commonly handled and shipped as a refrigerated liquid to reduce the risk of fire or explosions. This increases transportation and storage costs. Because of the hazardous nature of EO, the production of alkylamine ethoxylates requires special design of the reactor requiring a pressured reactor with a gas feeding pipe.

Even though alkylamine ethoxylates are difficult to manufacture, they are one of the most used adjuvants in pesticide formulations. An alkylamine ethoxylate molecule contains a hydrophilic portion (a tertiary nitrogen with various EO units) and a hydrophobic portion (hydrocarbon group) as shown for example in the following general structure:

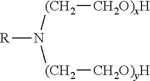

where R is a hydrocarbon group (i.e., the hydrophobic portion) of various chain lengths and x and y can adopt various values. It is this molecular structure that creates usefulness as adjuvants in agricultural applications. It is well known that the physical properties of an alkylamine ethoxylate can be altered by varying the hydrocarbon chain length and the number of EO units to suit various application needs.

One of the well-known applications of alkylamine ethoxylates is in glyphosate herbicide formulations as a potentiator adjuvant. It is known in the art that, in the alkylamine ethoxylate family, an alkylamine ethoxylate with a longer hydrocarbon chain length (about C18 or longer) and a higher number of EO units (higher than about 10) is more efficacious for glyphosate. It is also a common practice to use high load glyphosate formulations [e.g., 540 g/l ae (acid equivalent) glyphosate in water] to minimize transportation costs and storage costs because high load formulations carry less water. An effective formulation requires a sufficient amount of adjuvants, typically>˜10% in formulations. However, an alkylamine ethoxylate with a long carbon chain length (>=˜C18) and with an EO unit >=˜5 may not be compatible in a high load formulation, leading to a low cloud point (the temperature at which the sample turns from clear to hazy as the temperature increases) and eventual phase separation. To be able to include a sufficient amount of an effective alkylamine ethoxylate adjuvant in the high load formulations, a hydrotrope or compatibility agent generally must be used (WO2010036996). However, hydrotropes or compatibility agents do not significantly contribute to bioefficacy enhancing effect and their use increases the total costs of formulations.

To produce alkylamine derivatives useful for agricultural applications, hydrocarbons with various chain lengths are readily available, but hydrophilic groups have limited choices besides ethylene oxide. It is desirable to have alkylamine derivatives that behave similarly to alkylamine ethoxylates in agricultural applications but that also: (1) are less hazardous while handling the components; (2) allow easier manufacturing conditions; and (3) possess better compatibility in high load pesticide formulations. The subject matter of the current disclosure provides these advantages over what is currently known in the art. In addition, other objects, desirable features and characteristics will become apparent from the subsequent summary and detailed description, and the appended claims, taken in conjunction with the accompanying drawings and this background.

### BRIEF SUMMARY

This disclosure provides an agricultural composition comprising at least one agrochemical and at least one alkylamine glycidol surfactant of the structure I:

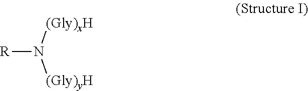

where R is C4-C22 linear or branched, saturated or non-saturated hydrocarbon group with or without pendant hydroxyl groups; x is about 0 to about 30; y is about 0 to about 30; x+y≥about 2 and up to about 30, and Gly is a glyceryl residue.

### BRIEF DESCRIPTION OF THE DRAWING

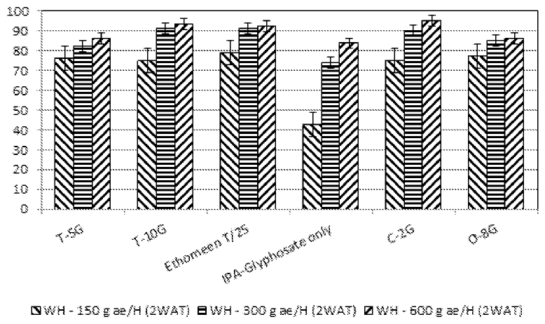

The present disclosure will hereinafter be described in conjunction with the following FIGURE, wherein FIG. 1 is a graph showing the results of the bio-efficacy study of Example 9.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description.

The present disclosure generally relates to nitrogen containing surfactants, i.e., alkyl polyglycerylamine (or alkylamine glycidol surfactant), obtained by the reaction of alkylamine and glycidol. Unexpectedly, the alkyl polyglycerylamine surfactants of the present disclosure have better compatibility than alkylamine ethoxylates in high load agricultural formulations without the need for compatibility agents. In particular, alkyl polyglycerylamine surfactants of the present disclosure are compatible in high load herbicide formulations containing herbicides such as 2,4-D salt, dicamba salt, glyphosate salt, and glufosinate salt without the need for a hydrotrope (compatibility agent) and can be used as a (co) emulsifier in pesticide formulations.

Alkyl polyglycerylamine, obtained by reacting an alkylamine with glycidol, is an improvement over alkylamine ethoxylates. Glycidol is a liquid and is less hazardous than ethylene oxide based upon its classifications by various government bodies. Therefore, the handling of glycidol and the manufacturing of alkyl polyglycerylamine are easier compared to the handling of EO and the manufacture of alkylamine ethoxylates.

In one embodiment, the present disclosure is an agricultural composition comprising at least one agrochemical and at least one alkyl polyglycerylamine surfactant selected from the following general structure (I):

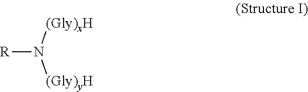

where R is C4-C22 linear or branched, saturated or non-saturated hydrocarbon group with or without pendant hydroxyl groups; x is about 0 to about 100, preferably about 1 to about 20, more preferably about 1 to about 10, more preferably about 1 to about 5; y is about 0 to about 100, preferably about 1 to about 20, more preferably about 1 to about 10, more preferably about 1 to about 5; and x+y≥about 2. In various embodiments, x is from about 0 to about 30 and y is from about 0 to about 30 wherein x+y≥about 2 and up to about 30. In other embodiments, x is from about 0 to about 30 and y is from about 0 to about 30 wherein x+y≥about 3 and up to about 30.

Gly is a glyceryl residue. The polyglyceryl moiety formed when x or y is greater than about 1 can be linear or branched. A linear polyglyceryl moiety could have the following formula (II).

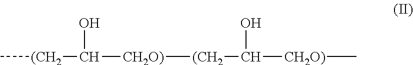

A branched polyglyceryl moiety could have the following formula (III).

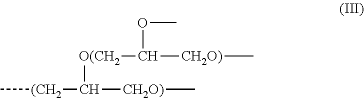

In some embodiments, the polyglyceryl moiety can include both branched and linear segments.

In another embodiment, the present disclosure is a pesticide composition comprising at least one pesticide and at least one alkyl polyglycerylamine surfactant of structure (I).

In still another embodiment, the present disclosure is a composition comprising the alkyl polyglycerylamine surfactant of structure (I) and a diluent selected from water, glycols, or liquid alcohol alkoxylate.

The alkyl polyglycerylamine surfactant of the disclosure has the following general structure (I):

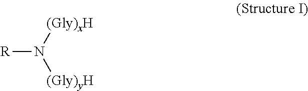

where R is C4-C22 linear or branched, saturated or non-saturated hydrocarbon group with or without pendant hydroxyl groups; x is about 0 to about 100, preferably about 1 to about 20, more preferably about 1 to about 10, more preferably about 1 to about 5; y is about 0 to about 100, preferably about 1 to about 20, more preferably about 1 to about 10, more preferably about 1 to about 5; and x+y≥about 2. In one embodiment R is C16-C18. In one embodiment R is C12-C16. In one embodiment, R is a hydrocarbon group derived from tallow, coco, oleyl, and combinations thereof. In various embodiments, x is from about 0 to about 30 and y is from about 0 to about 30 wherein x+y≥about 2 and up to about 30. In other embodiments, x is from about 0 to about 30 and y is from about 0 to about 30 wherein x+y≥about 3 and up to about 30. In such embodiments, the alkylamine glycidol surfactant may be described as an alkylamine polyglycidol surfactant. In various non-limiting embodiments, it is expressly contemplated that all values and ranges of values including and between those set forth above are herein expressly contemplated for use. It is contemplated that two or more of these surfactants may be combined together in a surfactant composition.

Gly is a glyceryl residue. The polyglyceryl moiety formed when x or y is greater than about 1 can be linear or branched. A linear polyglyceryl moiety could have the following formula (II).

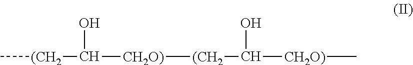

A branched polyglyceryl moiety could have the following formula (III).

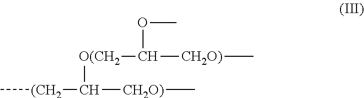

Propagation of the polyglyceryl moiety can be from the terminal primary hydroxyl of a glyceryl residue (resulting in a linear segment), or from the non-terminal secondary hydroxyl of the glyceryl residue (resulting in a branched segment).

In still other embodiments, the surfactant may be further defined as a soyalkylamine based polyglycerylamine, as understood by one of skill in the art. For example, is it known that the typical composition of soybean oil is as follows:

Soybean oil: about 14% saturated; about 81% unsaturated

| Approximate % | Fatty group |
|---|---|
| 10 | palmitic 16:0 saturated C16 |
| 4 | stearic 18:0 saturated C18 |
| 23 | oleic 18:1 n-9 mono-unsaturated C18 |
| 51 | linoleic 18:2 n-6 Di-unsaturated C18 |
| 7 | linolenic 18:3 n-3 Tri-unsaturated C18 |

Accordingly, it is contemplated that the “R” group described above may reflect, be, or represent one or more of these substituents of soybean oil. For example, R may be formed from, or be chosen from, a palmitic moiety, a stearic moiety, an oleic moiety, a linoleic moiety, a linolenic moiety, or combinations thereof. Alternatively, the R group may be a described as a fatty group that is chosen from any one or more of the those set forth above. Even further, combinations of different soyalkylamine based polyglycerylamines may be formed wherein each includes one or more of the aforementioned groups.

As used herein, an agrochemical is a chemical used in agricultural formulations. Non-limiting examples of agrochemicals include fertilizers, micronutrients, activator adjuvants or potentiators, drift control agents, emulsifiers, deposition aids, water conditioners, wetting agents, dispersants, compatibility agents, suspension aids, pesticides such as herbicides, fungicides, and insecticides, and growth inhibitors.

One embodiment of the present disclosure is a herbicide formulation containing the alkyl polyglycerylamine surfactants of the present disclosure. Suitable herbicides include, but are not limited to, acetochlor, acifluorfen, aclonifen, alachlor, ametryn, amidosulfuron, aminopyralid, amitrole, anilofos, asulam, atrazine, azafenidin, azimsulfuron, benazolin, benfluralin, bensulfuron-methyl, bentazone, bifenox, binalafos, bispyribac-sodium, bromacil, bromoxynil, butachlor, butroxidim, cafenstrole, carbetamide, carfentrazone-ethyl, chloridazon, chlorimuron-ethyl, chlorobromuron, chlorotoluron, chlorsulfuron, cinidon-ethyl, cinosulfuron, clethodim, clomazone, clopyralid, cloransulam-methyl, clorsulfuron, cyanazine, cycloate, cyclosulfamuron, cycloxydim, dalapon, desmedipham, dicamba, dichlobenil, dichlormid, diclosulam, diflufenican, dimefuron, dimepipeate, dimethachlor, dimethenamid, diquat, diuron, esprocarb, ethalfluralin, ethametsulfuron-methyl, ethofumesate, ethoxysulfuron, fentrazamide, flazasulfuron, florasulam, fluchloralin, flufenacet, flumetsulam, flumioxazin, fluometuron, flupyrsulfuron-methyl, flurochloridone, fluroxypyr, flurtamone, fomesafen, foramsulfuron, glufosinate, hexazinone, imazamethabenz-m, imazamox, mazapic, imazapyr, imazaquin, imazethapyr, imazosulfuron, iodosulfuron, ioxynil, isoproturon, isoxaben, isoxaflutole, Lactofen, lenacil, linuron, mefenacet, mesosulfuron-methyl, mesotrione, metamitron, metazachlor, methabenzthiazuron, metobromuron, metolachlor, metosulam, metoxuron, metribuzin, metsulfuron-methyl, molinate, MSMA, napropamide, nicosulfuron, norflurazon, oryzalin, oxadiargyl, oxadiazon, oxasulfuron, oxyfluorfen, paraquat, pendimethalin, phenmedipham, picloram, pretilachlor, profoxydim, prometryn, propanil, propisochlor, propoxycarbazone, propyzamide, prosulfocarb, prosulfuron, pyraflufen-ethyl, pyrazosulfuron, pyridate, pyrithiobac, quinclorac, quinmerac, rimsulfuron, sethoxydim, simazine, s-metolachlor, sulcotrione, sulfentrazone, sulfosulfuron, tebuthiuron, tepraloxydim, terbuthylazine, terbutryn, thifensulfuron-methyl, thiobencarb, tralkoxydim, tri-allate, triasulfuron, tribenuron-methyl, triclopyr, trifloxysulfuron, trifluralin, triflusulfuron-methyl, tritosulfuron, and mixtures and combinations thereof. Preferred herbicides are acetochlor, atrazine, dicamba, glufosinate, paraquat, glyphosate, 2,4-D and mixtures and combinations thereof. More preferred herbicides are 2,4-D, atrazine, dicamba, glyphosate, and glufosinate and mixtures and combinations thereof. The most preferred herbicides are glyphosate and glufosinate. When the herbicide is an acid, it can be used in the acid form though it is preferred that the herbicide be in the salt form selected from at least one of the group of an amine, lithium, sodium, ammonium or potassium. It shall be pointed out that when a pesticide appears in the text as a general name without specifying the counterions, it means both its acid form and salt form throughout the specification.

Another embodiment of the present disclosure is a fungicide formulation containing the alkyl polyglycerylamine surfactants of the present disclosure. Examples of suitable fungicides include, but are not limited to, acibenzolar-S-methyl, aldimorph, amisulbrom, anilazine, azaconazole, azoxystrobin, benalaxyl, benodanil, benomyl, benthiavalicarb, binapacryl, biphenyl, bitertanol, blasticidin-S, boscalid, bromuconazole, bupirimate, captafol, captan, carbendazim, carboxin, carpropamid, chloroneb, chlorothalonil, chlozolinate, copper, cyazofamid, cyflufenamid, cymoxanil, cyproconazole, cyprodinil, dichlofluanid, diclocymet, diclomezine, dicloran, diethofencarb, difenoconazole, diflumetorim, dimethirimol, dimethomorph, dimoxystrobin, diniconazole, dinocap, dithianon, dodemorph, dodine, edifenphos, enestrobin, epoxiconazole, etaconazole, ethaboxam, ethirimol, etridiazole, famoxadone, fenamidone, fenarimol, fenbuconazole, fenfuram, fenhexamid, fenoxanil, fenpiclonil, fenpropidin, fenpropimorph, fentin acetate, fentin chloride, fentin hydroxide, ferbam, ferimzone, fluazinam, fludioxonil, flumorph, fluopicolide, fluoxastrobin, fluquinconazole, flusilazole, flusulfamide, flutolanil, flutriafol, folpet, fosetyl-Al, fthalide, fuberidazole, furalaxyl, furametpyr, guazatine, hexaconazole, hymexazole, imazalil, imibenconazole, iminoctadine, iodocarb, ipconazole, iprobenfos (IBP), iprodione, iprovalicarb, isoprothiolane, isotianil, kasugamycin, kresoxim-methyl, laminarin, mancozeb, mandipropamid, maneb, material of biological, mepanipyrim, mepronil, meptyldinocap, metalaxyl, metalaxyl-M, metconazole, methasulfocarb, metiram, metominostrobin, metrafenone, mineral oils, organic oils, myclobutanil, naftifine, nuarimol, octhilinone, ofurace, origin, orysastrobin, oxadixyl, oxolinic acid, oxpoconazole, oxycarboxin, oxytetracycline, pefurazoate, penconazole, pencycuron, penthiopyrad, phophorous acid and, picoxystrobin, piperalin, polyoxin, potassium bicarbonate, probenazole, prochloraz, procymidone, propamocarb, propiconazole, propineb, proquinazid, prothiocarb, prothioconazole, pyraclostrobin, pyrazophos, pyribencarb, pyributicarb, pyrifenox, pyrimethanil, pyroquilon, quinoxyfen, quintozene (PCNB), salts, silthiofam, simeconazole, spiroxamine, streptomycin, sulphur, tebuconazole, teclofthalam, tecnazene (TCNB), terbinafine, tetraconazole, thiabendazole, thifluzamide, thiophanate, thiophanate-methyl, thiram, tiadinil, tolclofosmethyl, tolylfluanid, triadimefon, triadimenol, triazoxide, tricyclazole, tridemorph, trifloxystrobin, triflumizole, triforine, triticonazole, validamycin, valiphenal, vinclozolin, zineb, ziram, and zoxamide, and mixtures and combinations thereof.

Still another embodiment of the present disclosure is an insecticide formulation containing the alkylamine glycidol surfactants of the present disclosure. Examples of suitable insecticides include, but are not limited to, kerosene or borax, botanicals or natural organic compounds (nicotine, pyrethrin, strychnine and rotenone), chlorinated hydrocarbon (DDT, lindane, chlordane), organophosphates (malathion and diazinon), carbamates (carbaryl and propoxur), fumigants (naphthalene) and benzene (mothballs), synthetic pyrethroids, and mixtures and combinations thereof.

One embodiment of the present disclosure is a surfactant composition comprising alkyl polyglycerylamine of structure (I) and a diluent, wherein the concentration of the alkyl polyglycerylamine is from about 30-about 90%, preferably from about 40-about 80%, or more preferably from about 50-about 75%. Preferably the diluent is selected from water, glycols, liquid alcohol alkoxylate, or combinations thereof.

Yet still another embodiment of the present disclosure is a mixture containing any herbicide, fungicide, and insecticide selected from the above groups and further containing one or more alkyl polyglycerylamine surfactants of the present disclosure.

The alkyl polyglycerylamine surfactants of the present disclosure can be used as a tank-mix additive or formulated in an in-can formulation. They are suitable in solid pesticide formulations and, particularly, in liquid pesticide formulations.

Other additives that can be present in the formulations of the present disclosure are defoamers, diluents, compatibility agents, biocides, thickeners, drift control agents, dyes, fragrances, and chelating agents. The use of a compatibility agent may not be necessary due to the high compatibility of alkyl polyglycerylamine surfactants in high load pesticide formulations.

The use concentration of the alkyl polyglycerylamine surfactant of the present disclosure in an in-can pesticide formulation may be from about 0.005% to about 30%, preferably about 0.05% to about 20%, and more preferably about 0.5% to about 15% in weight %. The pesticide concentration is from about 5% to about 65%, preferably from about 10% to about 60%, and more preferably from about 30% to about 55%, and still more preferably from about 40% to about 55%, based on weight % active ingredient.

The use concentration of the alkyl polyglycerylamine surfactant of the present disclosure in a tank mix pesticide spray solution may be from about 0.001% to about 5%, preferably about 0.01% to about 2%, and more preferably about 0.1% to about 1% (in weight % surfactant basis) in the total spray solution.

Also disclosed is a method of treating plants or vegetation with the compositions of the disclosure. The method comprises applying an effective amount of the agricultural composition to plants (particularly crops) to kill or control pests. The agricultural composition listed above is contacted with the pest. The agricultural composition may be used in the above listed form or diluted with water or an appropriate diluent.

All units are in approximate weight percent (i.e., wt %).

The surfactants of the disclosure may also be used with other surfactants such as alkylamine alkoxylates and their quaternaries, anionic surfactants such as alkyl or ether sulfate, alkyl or aryl sulfonate, phosphate ester and ethoxylated phosphate ester, nonionic surfactants such as alcohol alkoxylates, alkyl (C6-C18) polyglucoside, amphoteric surfactants, quaternary surfactants, and silicone surfactants.

In additional embodiments, the disclosure provides an agricultural composition comprising at least one agrochemical and at least one alkylamine glycidol surfactant of the structure I:

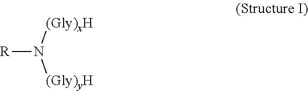

where R is C4-C22 linear or branched, saturated or non-saturated hydrocarbon group with or without pendant hydroxyl groups; x is about 0 to about 30, preferably about 1 to about 20, more preferably about 1 to about 10, more preferably about 1 to about 5; y is about 0 to about 30, preferably about 1 to about 20, more preferably about 1 to about 10, more preferably about 1 to about 5; x+y≥about 2 and up to about 30, and Gly is a glyceryl residue.

In one embodiment, x+y≥about 3 and up to about 30.

In another embodiment, x+y is from about 5 to about 20.

In another embodiment, x+y is from about 2 to about 10.

In another embodiment, x and/or y>about 1 such that the polyglyceryl moiety is linear, branched or has both linear and branched segments.

In another embodiment, the agrochemical is a pesticide, herbicide, fungicide, or insecticide.

In another embodiment, the agrochemical is an organophosphorus herbicide, preferably glyphosate or glufosinate.

In a further embodiment, the agrochemical is an auxin herbicide, preferably dicamba or 2,4-D.

In still another embodiment, the agrochemical is a conazole fungicide, preferably a triazole fungicide, and more preferably it is tebuconazole.

In another embodiment, the agrochemical is a pyrethroid insecticide, preferably a pyrethroid ester insecticide.

In another embodiment, the pyrethroid ester insecticide is bifenthrin.

In another embodiment, R is C16-C18.

In a further embodiment, R is C12-C16.

In another embodiment, R is a hydrocarbon group derived from tallow, coco, oleyl, and combinations thereof.

In various embodiments, x is from about 0 to about 30 and y is from about 0 to about 30 wherein x+y≥about 2 and up to about 30. In other embodiments, x is from about 0 to about 30 and y is from about 0 to about 30 wherein x+y≥about 3 and up to about 30. In such embodiments, the alkylamine glycidol surfactant may be described as an alkylamine polyglycidol surfactant. In various non-limiting embodiments, it is expressly contemplated that all values and ranges of values including and between those set forth above are herein expressly contemplated for use. It is contemplated that two or more of these surfactants may be combined together in a surfactant composition.

This disclosure also provides a method of treating vegetation, wherein the method comprises applying an effective amount of the agricultural composition as described above to vegetation.

This disclosure also contemplates the surfactant itself apart from the agricultural composition, i.e., any embodiment of the surfactant above.

The following non-limiting examples are presented to further illustrate and explain the present disclosure.

### Examples

### Example 1. Synthesis of Alkyl Polyglycerylamine Surfactants

Raw-materials used

### Tallowamine Armeen TM-97 (AkzoNobel)

### Oleylamine Armeen OM-97 (AkzoNobel)

### Cocoalkylamine Armeen CD (AkzoNobel)

### Glycidol Acros

### Abbreviations Used

“T” for “tallowamine”, “0” for oleylamine”, “C” for “cocoamine”, and G for Glycerol units.
For example:
T-5G (i.e., tallowamine 5G) means tallowamine with 5 glycerol units.
O-6G (i.e., oleylamine 6G) means oleylamine with 6 glycerol units.
C-2G (i.e., cocoamine 2G) means cocoamine with 2 glycerol units.

TABLE 1
Synthesis/Compound Examples

| Sample | Description (Amine + approx. | |
|---|---|---|
| # | theoretical average glycerol units) | |
| 1 | Tallowamine-5G | T-5G |
| 2 | Tallowamine-10G | T-10G |
| 3 | Oleylamine-6G | O-6G |
| 4 | Oleylamine-8G | O-8G |
| 5 | Oleylamine-10G | O-10G |
| 6 | Cocoalkylamine-2G | C-2G |
| 7 | Cocoalkylamine-4.4G | C-4.4G |
| 8 | Oleylamine-20G | O-20G |

### Synthesis Procedure

The following procedure was used to create sample #1, and similar procedures were used to synthesize the additional samples, with the relevant fatty acid amine and glycidol molar ratios adjusted appropriately (as discussed below).

Glycidol (44.4 g, 0.6 mol) was added dropwise over a period of 3 hrs to tallowamine (32.04 g, 0.12 mol) stirred in a round bottom flask under nitrogen atmosphere keeping the temperature of the reaction mixture between 80° to 120° C. The reaction mixture was further stirred for about an hour at around 110° 420° C. until IR analysis showed no more epoxide peaks around 840 cm⁻¹ due to glycidol. A clear pale brown viscous liquid product thus obtained was collected.

The products thus obtained can optionally be further diluted by adding necessary amount of water or other solvents/diluents.

For Samples #2-#8, the process for Sample #1 was repeated using the indicated amine in the relevant molar ratio with glycidol. For example, for Sample #2, the process of Sample #1 was repeated using a molar ratio of 1:10 for tallowamine and glycidol, Sample #3 used a molar ratio of 1:6 for oleylamine and glycidol, Sample #4 used a molar ratio of 1:8 for oleylamine and glycidol, and so forth.

It is to be expected that side products such as polyglycerol can be formed in the final product. The samples described herein and in the following examples were used without further purification.

### Example 2. Diluted Alkyl Polyglycerylamine Compositions

Some alkyl polyglycerylamine samples (active ingredient plus biproducts such as polyglycerols) are honey-like (very high viscosity) and are difficult to handle. Moreover, these products can form hard gels when added to water (or an aqueous solution) and the gels can take a long time to dissolve. These surfactants can be converted into easy to handle products in practice. Several diluents were found to be effective in reducing the viscosity of the products and minimizing the gel forming potential. The examples are shown in Table 2.

TABLE 2
Effect of diluent on gel formation

| | | wt % of | | | |
|---|---|---|---|---|---|
| | Alkylamine | Alkylamine | | wt % | |
| Smpl | Glycidol | Glycidol | Diluent | Diluent | Comment |
| 1A | T-5G | 5 | Water | 95 | Sample #1 (T-5G) itself is |
| | | | | | stringy and slightly flowable |
| | | | | | (when heated to >30° C.) and |
| | | | | | forms gels in water. The sample |
| | | | | | was heated to 100° C. and still |
| | | | | | took >30 min to dissolve. |
| 1B | T-5G | 60 | Water | 40 | Hard gel. |
| 1C | T-5G | 76.66 | Propylene | 23.34 | Heated to 80° C. Mixed to a |
| | | | glycol | | clear solution. Flowable at room |
| | | | | | temperature (RT). No gelling |
| | | | | | when added to water. PG is a |
| | | | | | good diluent. |
| 3A | O-6G | 70 | Water | 30 | Need heating of O-6G. Hard gel |
| 3B | O-6G | 58.33 | Water | 41.67 | Hard gel. |
| 3C | O-6G | 70 | 2- | 30 | Heated to dissolve into a clear |
| | | | Ethylhexyl | | and flowable liquid (at RT). |
| | | | alcohol | | Dissolved in 2-ethylhexyl |
| | | | | | alcohol quickly without gelling. |
| | | | | | 2-EH alcohol good performance |
| | | | | | as diluent. |
| 3D | O-6G | 70 | 2-Ethylhexyl | 30 | Heated to dissolve into a clear |
| | | | alcohol- | | and flowable liquid (at RT). |
| | | | 4EO | | Dissolved in water quickly |
| | | | | | without gelling. 2-EH-4EO |
| | | | | | good performance as diluent. |
| 3E | O-6G | 12.4 | Soy oil | 87.6 | Heated to a hazy and |
| | | | | | homogeneous liquid; separated |
| | | | | | at RT. |
| 4A | O-8G | 5 | Water | 95 | Formed gel initially. Long |
| | | | | | dissolution time |
| 4B | O-8G | 66.67 | Propylene | 33.33 | Heated to 80° C. Mix to a clear |
| | | | glycol | | solution. Flowable at RT. |
| | | | | | Dissolved in water quickly |
| | | | | | without gelling. PG good |
| | | | | | performance as diluent. |
| 4C | O-8G | 71.86 | 2- | 28.14 | Heated to 80° C. Mixed to a |
| | | | Ethxylhexyl | | clear and viscous solution. |
| | | | alcohol | | Flowable at RT. Dissolved in |
| | | | | | water quickly without gelling. |
| | | | | | 2-EH good diluent. |
| 4D | O-8G | 22.76 | Soy methyl | 77.24 | Heated to a hazy and |
| | | | ester | | homogeneous liquid, separated |
| | | | | | at RT. |
| 2A | T-10G | 5 | Water | 95 | Sample #2 (T-10G) itself has |
| | | | | | thick honey feel (not-flowable |
| | | | | | at RT) and stringy, and gelled |
| | | | | | upon adding water. Heated to |
| | | | | | >80° C. and the gel softened and |
| | | | | | dissolved to a slightly hazy |
| | | | | | solution. |
| 2B | T-10G | 72.68 | Propylene | 27.32 | Heated to >80° C. and mixed |
| | | | glycol | | well to a clear viscous solution. |
| | | | | | The final sample is flowable at |
| | | | | | RT. Dissolved in water quickly |
| | | | | | without gelling. PG good |
| | | | | | diluent for T-10G |
| 2C | T-10G | 70 | Water | 30 | Heated to >80° C. and mixed |
| | | | | | well to a clear viscous solution. |
| | | | | | The final sample is flowable at |
| | | | | | RT and it dissolved in water |
| | | | | | quickly without gelling. Water |
| | | | | | good diluent for T-10G |
| 5A | O-10G | 70 | Water | 30 | Heated to >80° C. and mixed |
| | | | | | well to a clear viscous solution. |
| | | | | | The final sample is flowable at |
| | | | | | RT and dissolved in water |
| | | | | | quickly without gelling. Water |
| | | | | | is a good diluent for O-10G |
| 7A | O-20G | 70 | Water | 30 | Heated to >80° C. and mixed |
| | | | | | B well to a clear viscous solution. |
| | | | | | The final sample is flowable at |
| | | | | | RT and dissolved in water |
| | | | | | quickly without gelling. Water |
| | | | | | is a good diluent for O-20G |

As shown in Table 2, alkyl polyglycerylamine surfactants of the disclosure can be diluted to improve handling and workability.

### Example 3. Alkyl Polyglycerylamine in Aqueous High Load Pesticide Formulations

Compatibilities of various alkyl polyglycerylamine surfactants with comparative examples in high load pesticide formulations were obtained in Table 3.

High load pesticide formulations have advantages of shipping less water and using less material for shipping containers. However, high load formulations can be difficult to incorporate the amount of adjuvants necessary for efficacy because the high load formulation frequently becomes separated at >55° C. storage temperature. Typically, the amount of the adjuvant in formulation preferably is at least 8 wt % for acceptable efficacy.

TABLE 3
Compatibilities of various alkyl polyglycerylamines
with comparative examples in high load pesticide formulations

| | | Wt % | Wt | | Wt | |
|---|---|---|---|---|---|---|
| | Name of | of | % of | Name of | % of | |
| Smpl | Pesticide | Pest. | H2O | Surfactant | Surf | Comment |
| 3.1 | Glufosinate | 85 | | 70% T-10G in | 15 | Clear from −25° C. to >85° C. |
| | (50% ai) | | | water | | |
| 3.2* | Glufosinate | 75 | 16.67 | Tallowamine | 8.33 | Room Temperature (RT) |
| | (50% ai) | | | 10EO | | clear. Cloud point (CP) 48° C. |
| 3.3 | Glufosinate | 83.3 | | 60% T-5G in | 16.7 | −25 C° hazy. Clear 0° C. to |
| | (50% ai) | | | water | | >85° C |
| 3.4* | Glufosinate | 75 | 16.67 | Tallowamine | 8.33 | 0° C. hazy and frozen. RT |
| | (50% ai) | | | 5EO | | clear. Cloud point 35° C. |
| | | | | | | Viscous |
| 3.5 | Glyphosate, K | 82.2 | 7.8 | T-10G | 10 | 0° C. clear. RT clear. Cloud |
| | (48.2% ae) | | | | | point ~60° C. Took a few hrs |
| | | | | | | to dissolve gels. |
| 3.6* | Glyphosate, K | 72 | 24 | Tallowamine | 4 | RT clear. Cloud point 35° C. |
| | (48.2% ae) | | | 10EO | | |
| 3.7 | Glyphosate, K | 82.2 | 7.8 | T-5G | 10 | RT and >85° C. clear. |
| | (48.2% ae) | | | | | Overnight dissolution of |
| | | | | | | gels. |
| 3.8* | Glyphosate, K | 84.34 | 5.66 | Tallowamine | 10 | Cloud point ~42° C. |
| | (47% ae) | | | 5EO | | |
| 3.9 | Base camp | 85 | | 70% T-10G in | 15 | 0° C., RT and >85° C. clear |
| | Amine (46.8% | | | water | | |
| | 2,4-D DMA) | | | | | |
| 3.10 | Base camp | 83.3 | | 60% T-5G in | 16.7 | 0° C., RT and >85° C. clear. |
| | Amine (46.8% | | | water | | Heated to dissolve. |
| | 2,4-D DMA) | | | | | |
| 3.11 | Base camp | 90 | | O-6G | 10 | Heated to 80° C., took >10 |
| | Amine (46.8% | | | | | minutes to dissolve. |
| | 2,4-D DMA) | | | | | |
| 3.12 | Dicamba-MIPA | 85 | | 70% T-10G in | 15 | RT and >85° C. clear |
| | (40% ae) | | | water | | |
| 3.13 | Dicamba-MIPA | 83.3 | | 60% T-5G in | 16.7 | Clear RT and >85° C. |
| | (40% ae) | | | water | | Heated to dissolve. |
| 3.14 | Glufosinate | 90 | | O-10G | 10 | Heated to >85° C., dissolved |
| | (50% AI), NH4 | | | | | easily. CP > 100° C. −25° C |
| | | | | | | clear and flowable |
| 3.15 | Glufosinate | 88 | | O-8G | 12 | Heated to >85° C., dissolved |
| | (50% AI), NH4 | | | | | easily. CP > 100° C. −25° C |
| | | | | | | clear and flowable |
| 3.16 | Glufosinate | 89.3 | | O-6G | 10.7 | Heated to >85° C., dissolved |
| | (50% AI), NH4 | | | | | easily. CP > 100° C. −25° C |
| | | | | | | clear and flowable |
| 3.17 | Dicamba, MIPA | 90 | | O-10G | 10 | Heated to >85° C., dissolved |
| | (40% ae) | | | | | easily. CP > 100° C. |
| 3.18 | Dicamba, MIPA | 89.3 | | O-6G | 10.7 | Heated to >85° C., dissolved |
| | (40% ae) | | | | | easily. CP > 100° C. |
| 3.19 | Glyphosate, K | 82.2 | 7.8 | O-6G | 10 | CP > 80° C. Took ~2 days to |
| | (~48.2% ae) | | | | | fully dissolve the gels |
| 3.20 | Glyphosate, K | 82.2 | 7.8 | O-8G | 10 | CP > 80° C. Took 3-4 days to |
| | (~48.2% ae) | | | | | fully dissolve the gels |
| 3.21 | Glyphosate, K | 82.2 | 7.8 | O-10G | 10 | CP = ~40° C |
| | (~48.2% ae) | | | | | |
| 3.22 | 24D IOE (with | 84.8 | | O-8G: Emulpon | 15.2 | RT slightly hazy. Adding 1.5 |
| | 10.38% 2 EH | | | CO-360** (1:1) | | g of this sample into 24 g tap |
| | alcohol) | | | | | water formed a white |
| | | | | | | emulsion. This suggested O- |
| | | | | | | 8G could be used as a co- |
| | | | | | | emulsifier. |
| 3.23 | Glyphosate, K | 82.2 | 7.8 | C-2G | 10 | CP > 80° C. |
| | (48.2% ae) | | | | | |
| 3.24 | Glyphosate, K | 82.2 | 7.8 | C-4.4G | 10 | CP > 80° C. |
| | (48.2% ae) | | | | | |
| 3.25* | Glyphosate, K | 82.2 | 12.8 | Cocoamine- | 5 | Hazy and separated at RT |
| | (48.2% ae) | | | 9EO-2PO oxide | | |
| | | | | (70% in water) | | |
| 3.26 | Glyphosate, K | 82.2 | 7.8 | C-2G/ | 10 | CP > 80° C. C-2G is suitable |
| | (48.2% ae) | | | Cocoamine-9EO-2PO oxide | | as hydrotrope. |
| | | | | (70% in water) | | |
| | | | | (5:5) | | |
| 3.27 | Glyphosate, K | 82.2 | 7.8 | C-4.4G/ | 10 | CP = ~75° C. C-4.4G is |
| | (48.2% ae) | | | Cocoamine- | | suitable as hydrotrope. |
| | | | | 9EO-2PO oxide | | |
| | | | | (70% in water) | | |
| | | | | (5:5) | | |
| 3.28 | Glufosinate | 85 | | 70% O-20G in | 15 | Clear 0° C. to >85° C |
| | (50% ai) | | | water | | |
| 3.29 | Base camp | (46.8% | 85 | 70% O-20G in | 15 | Clear 0° C. to >85° C |
| | Amine | | | water | | |
| | 2,4-D DMA) | | | | | |
| 3.30 | Dicamba, MIPA | 85 | | 70% O-20G in | 15 | Clear 0° C. to >85° C |
| | (40% ae) | | | water | | |

*comparative example
**Emulpon CO-360 is castor oil ethoxylate, a well-known emulsifier.

The results show that the alkyl polyglycerylamine in Table 3 have better compatibility in high load pesticide formulations than their counterparts based on alkylamine ethoxylates. In some cases (e.g. samples 3.26, 3.27), they can even function as a hydrotrope (an ability to help dissolve more incompatible components). In other cases (3.22), the alkyl polyglycerylamine shows emulsification ability.

### Example 4. Synergy in Emulsion Performance Between Emulsifiers (Alkyl Polyglycerylamine/Alkyl EO-PO Block Copolymer) in Tebuconazole Fungicide Emulsifiable Concentrate Formulations

It is generally known in the art that three emulsifiers working together are generally needed to form a good emulsifier concentrate (EC). In some cases, only two emulsifiers may be necessary. In rare situations, one emulsifier can be sufficient. The performance of ECs depends on proper selection of the emulsifiers and concentration of the emulsifiers.

To evaluate the alkyl polyglycerylamine surfactants of the disclosure as potential emulsifiers, two tebuconazole emulsifiable concentrates (EC-1 and EC-2) containing O-8G, were mixed at various ratios. The emulsion was obtained by adding 1 g EC into 19 g water (5% dilution) in a 8-dram vial and inverting 10 times. The bloom of the emulsion (i.e., the ability to form white clouds immediately after adding to water) and emulsion quality were evaluated according to 4 scales: excellent, good, OK (fair), and bad. The emulsion performance results are shown in Table 4.

EC-1: 15% O-8G+85% tebuconazole pre-mix (30% tebuconazole in 70% Armid DM-10 C10 dimethylamide)

EC-2*: 15% Ethylan NS-500LQ (Alkyl EO-PO block copolymer)+85% tebuconazole pre-mix (30% tebuconazole in 70% Armid DM-10)

Ethylan NS-500LQ, a butyl EO/PO copolymer, is a well-known emulsifier. Armid DM-10 is a well-known hydrophobic solvent. EC-1 contains the O-8G alkyl polyglycerylamine of the disclosure. EC-2* is a comparative example.

TABLE 4
Synergy in emulsion performance between emulsifiers (alkyl polyglycerylamine/
alkyl EO-PO block copolymer) in tebuconazole fungicide emulsifiable concentrate
formulations

| Smpl | | wt % | | wt % | Emulsion performance of 5% dilution in water |
|---|---|---|---|---|---|
| 4.1 | EC-1 | 100 | EC-2 | 0 | Bad bloom, able to form emulsion (quality not good), |
| | | | | | separated in <30 mins. In 16 hrs, formed 3 phases: |
| | | | | | ~10% top (haze/oily), ~60% middle clear, ~30% |
| | | | | | bottom bluish microemulsion. |
| 4.2 | EC-1 | 50 | EC-2 | 50 | Excellent bloom and emulsion (no separation in 24 |
| | | | | | hrs). Showed synergy in emulsion performance. |
| 4.3 | EC-1 | 30 | EC-2 | 70 | Excellent bloom and emulsion (no separation in 24 |
| | | | | | hrs). Showed synergy in emulsion performance. |
| 4.4 | EC-1 | 10 | EC-2 | 90 | Good bloom and emulsion (24 hrs ~10% bottom clr). |
| | | | | | Showed synergy in emulsion performance. |
| 4.5 | EC-1 | 0 | EC-2 | 100 | Bad bloom, OK emulsion (~10% bottom clr in 30 |
| | | | | | mins and ~40% in 16 hrs) |

The result from table 4 indicates that O-8G has the potential to be a (co)emulsifier in a tebuconazole fungicide EC.

### Example 5. Synergy in Emulsion Performance Among Emulsifiers (Alkyl Polyglycerylamine/Alkyl EO-PO Block Copolymer/Ca DDBS) in Tebuconazole Fungicide Emulsifiable Concentrate Formulations

Three tebuconazole emulsifiable concentrates, EC-1, EC-2, and EC-3, were mixed at various ratios. The emulsion was obtained by adding 1 g EC into 19 g water (5% dilution) in a 8 dram vial and inverting 10 times. Bloom and emulsion quality were evaluated according to 4 scales: excellent, good, OK (fair), and bad. The emulsion performance results are shown in Table 5.

EC-1 and EC-2 were the same as in example 4.

EC-3*: 15% Witconate P-1220EH (60% Ca DDBS)+85% tebuconazole pre-mix (30% tebuconazole in 70% Armid DM-10)

Witconate P-1220EH is a well-known emulsifier containing ˜60% Ca dodecylbenzene sulfonate.

TABLE 5
Synergy in emulsion performance among emulsifiers (alkyl polyglycerylamine/alkyl EO-PO
block copolymer/Ca DDBS) in tebuconazole fungicide emulsifiable concentrate formulations

| Smpl | | wt % | | wt % | | wt % | Emulsion performance of 5% dilution in water |
|---|---|---|---|---|---|---|---|
| 5.1 | EC-1 | 50 | EC-2 | 0 | EC-3 | 50 | OK bloom, excellent emulsion (no separation 2 |
| | | | | | | | hrs). 16 hr few small oily drops only. Synergy |
| | | | | | | | in emulsion performance |
| 5.2 | EC-1 | 40 | EC-2 | 10 | EC-3 | 50 | Good bloom and emulsion (no separation 24 |
| | | | | | | | hrs). Synergy in emulsion performance |
| 5.3* | EC-1 | 0 | EC-2 | 0 | EC-3 | 100 | Bad bloom, bad emulsion. 16 hrs: 5% top hazy |
| | | | | | | | phase and 95% bottom phase (almost clr) |

The result from Table 5 indicates again that alkyl polyglycerylamine surfactants (such as O-8G) have the potential as a (co)emulsifier in a tebuconazole fungicide EC.

### Example 6. Synergy in Emulsion Performance Between Emulsifiers (Alkyl Polyglycerylamine and Alkyl EO-PO Block Copolymer) in Bifenthrin Insecticide Emulsifiable Concentrate Formulations

Two bifenthrin emulsifiable concentrates, EC-4 and EC-5, were mixed at various ratios. The emulsion was obtained by adding 1 g EC into 19 g water (5% dilution) in a 8 dram vial and inverting 10 times. Bloom and emulsion quality were evaluated according to 4 scales: excellent, good, OK (fair), and bad. The emulsion performance results are shown in Table 6.

EC-4: 8.1% O-10G+91.9% bifenthrin pre-mix (10% bifenthrin+40% Aromatic 200+50% Armid DM-10)

EC-5*: 8.1% Ethylan NS-500LQ+91.9% bifenthrin pre-mix (10% bifenthrin+40% Aromatic 200+50% Armid DM-10)

TABLE 6
Synergy in emulsion performance between emulsifiers (alkyl polyglycerylamine and
alkyl EO-PO block copolymer) in insecticide emulsifiable concentrate formulations.

| Smpl | | wt % | | wt % | Emulsion performance of 5% dilution in water |
|---|---|---|---|---|---|
| 6.1 | EC-4 | 100 | EC-5 | 0 | Bad bloom, bad emulsion (separated in 1 hr) |
| 6.2 | EC-4 | 90 | EC-5 | 10 | Excellent bloom and emulsion (5% cream in 2 hrs). |
| | | | | | Synergy in emulsion performance. |
| 6.3 | EC-4 | 80 | EC-5 | 20 | Excellent bloom and emulsion (4% cream in 2 hrs). |
| | | | | | Synergy in emulsion performance. |
| 6.4 | EC-4 | 70 | EC-5 | 30 | Excellent bloom and emulsion (5% cream in 2 hrs). |
| | | | | | Synergy in emulsion performance. |
| 6.5 | EC-4 | 50 | EC-5 | 50 | Good bloom, Good emulsion (6% cream in 2 hrs). Synergy |
| | | | | | in emulsion performance. |
| 6.6 | EC-4 | 30 | EC-5 | 70 | OK bloom, OK emulsion (7% cream in 2 hrs). Synergy in |
| | | | | | emulsion performance. |
| 6.7 | EC-4 | 10 | EC-5 | 90 | Bad bloom, OK emulsion (separated in 2 hrs) |
| 6.8* | EC-4 | 0 | EC-5 | 100 | Bad bloom, bad emulsion (~15% bottom clr in 10 mins) |

The result from Table 6 indicates that alkyl polyglycerylamine surfactants (such as O-10G) have the potential as a (co)emulsifier in a bifenthrin insecticide EC.

### Example 7. Synergy in Emulsion Performance Among Emulsifiers (Alkyl Polyglycerylamine/Alkyl EO-PO Block Copolymer/Ca-DDBS) in Insecticide Emulsifiable Concentrate Formulations

Three emulsifiable concentrates, EC-4, EC-5, and EC-6, were mixed at various ratios. The emulsion was obtained by adding 1 g EC into 19 g water (5% dilution) in a 8-dram vial and inverting 10 times. Bloom and emulsion quality were evaluated according to 4 scales: excellent, good, OK (fair), and bad. The emulsion performance results are shown in Table 7.

EC-4 and EC-5 were the same as in example 6.

EC-6*: 8.1% Witconate P-1220EH (60% Ca DDBS)+91.9% bifenthrin pre-mix (10% bifenthrin+40% Aromatic 200+50% Aramid DM-10).

TABLE 7
Synergy in emulsion performance among emulsifiers (alkylamine glycidol/alkyl
EO-PO block copolymer/Ca DDBS) in insecticide emulsifiable concentrate formulations

| Smpl | | wt % | | wt % | | wt % | Emulsion performance of 5% dilution in water |
|---|---|---|---|---|---|---|---|
| 7.1 | EC-4 | 60 | EC-5 | 10 | EC-6 | 30 | Excellent bloom and emulsion (no separation 2 |
| | | | | | | | hrs). Synergy in emulsion performance |
| 7.2 | EC-4 | 60 | EC-5 | 30 | EC-6 | 10 | Excellent bloom and emulsion (no separation 2 |
| | | | | | | | hrs). Synergy in emulsion performance |
| 7.3* | EC-4 | 0 | EC-5 | 0 | EC-6 | 100 | Bad bloom, bad emulsion (separated in 1 hr) |

The result from Table 7 indicates again that alkyl polyglycerylamine surfactants (such as 0-10G) have the potential as a (co)emulsifier in a bifenthrin insecticide EC.

### Example 8. Ability of Alkyl Polyglycerylamine Surfactants to Form Microemulsions

The following microemulsions were created:

| | Armid DM-10, | Water, | O-10G, | |
|---|---|---|---|---|
| Sample | wt % | wt % | wt % | Results |
| 8.1 | 65.87 | 6.46 | 27.67 | Clear water-in-oil |
| | | | | microemulsion. |
| 8.2 | 50.14 | 28.80 | 21.06 | Clear water-in-oil |
| | | | | microemulsion. |

The result from Table 8 indicates that alkyl polyglycerylamine surfactants (such as O-10G) can be used to form microemulsions.

### Example 9. Bio-Efficacy of IPA-Glyphosate with and without Alkyl Polyglycerylamine Surfactants in Green House Trial 2 Weeks after Treatment

In this example, Ethomeen T/25 tallowamine ethoxylate, a well-known adjuvant in pesticide formulations, was used as a positive control. The glyphosate only sample was used as the negative control. The wheat (a model plant) was sprayed at three rates: 150 g ae/H, 300 g ae/H and 600 g ae/H. The rating was obtained 2 weeks after treatment (WAT). The bioefficacy results as illustrated in the graph of FIG. 1 showed that alkyl polyglycerylamine, exemplified by T-5G, T-10G, C-2G, and O-8G, had better weed control performance than the glyphosate alone sample. The performance of T-5G, T-10G, C-2G, and O-8G were comparable to Ethomeen T/25.

It is expressly contemplated that, in various non-limiting embodiments, all combinations of the aforementioned components, compositions, method steps, and options for various substituents are contemplated for use herein every if they are not described in the same paragraph or expressly related to one another within a single embodiment set forth above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. An agricultural composition comprising at least one agrochemical and at least one alkylamine glycidol surfactant of the structure I: 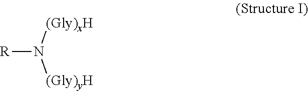
where R is C4-C22 linear or branched, saturated or non-saturated hydrocarbon group with or without pendant hydroxyl groups; x is about 0 to about 30; y is about 0 to about 30; x+y≥about 2 and up to about 30, and Gly is a glyceryl residue.

2. The agricultural composition of claim 1 wherein x+y≥about 3 and up to about 30.

3. The agricultural composition of claim 1 wherein x+y is from about 5 to about 20.

4. The agricultural composition of claim 1 wherein x+y is from about 2 to about 10.

5. The agricultural composition of claim 1 wherein x and/or y>about 1 such that the polyglyceryl moiety is linear, branched or has both linear and branched segments.

6. The agricultural composition of claim 1 wherein the agrochemical is a pesticide, herbicide, fungicide, or insecticide.

7. The agricultural composition of claim 1 wherein the agrochemical is an organophosphorus herbicide.

8. The agricultural composition of claim 1 wherein the agrochemical is an auxin herbicide.

9. The agricultural composition of claim 1 wherein the agrochemical is a conazole fungicide.

10. The agricultural composition of claim 1 wherein the agrochemical is a pyrethroid insecticide.

11. The agricultural composition of claim 10 wherein the pyrethroid ester insecticide is bifenthrin.

12. The agricultural composition of claim 1 wherein R is C16-C18.

13. The agricultural composition of claim 1 wherein R is C12-C16.

14. The agricultural composition of claim 1 wherein R is a hydrocarbon group derived from tallow, coco, oleyl, and combinations thereof.

15. A method of treating vegetation, wherein the method comprises applying an effective amount of the agricultural composition of claim 1 to the vegetation.

16. The composition of claim 1 wherein the agrochemical is glyphosate, glufosinate, or combinations thereof.

17. The composition of claim 1 wherein the agrochemical is dicamba, 2,4-D, or combinations thereof.

18. The composition of claim 1 wherein the agrochemical is tebuconazole.

19. The composition of claim 1 wherein x is about 1 to about 5 and y is about 1 to about 5.

20. The composition of claim 1 wherein x is about 1 to about 5, y is about 1 to about 5, and the agrochemical is glyphosate, glufosinate, dicamba, 2,4-D, bifenthrin, tebuconazole, or combinations thereof.
